(19) United States
(12) Patent Application Publication
(10) Pub. No.: US 2012/0273209 A1
(43) Pub. Date: Nov. 1, 2012

(54) WEGHTED PRESSURE RELIEF VALVE

(75) Inventors: Julian Austin, Surrey (GB); Mark Ezekiel, Magnolia, TX (US)

(73) Assignees: BP EXPLORATION OPERATING COMPANY LIMITED, Sunbury-on-Thames (GB); BP CORPORATION NORTH AMERICA INC., Houston, TX (US)

(21) Appl. No.: 13/453,264

(22) Filed: Apr. 23, 2012

Related U.S. Application Data
(60) Provisional application No. 61/479,671, filed on Apr. 27, 2011.

(51) Int. Cl. F16K 17/12; E21B 34/04

(52) U.S. Cl. 166/321; 137/532

(57) ABSTRACT

A subsea pressure relief valve includes a water-filled nozzle fluidly connected to a hydrocarbon distribution manifold. A valve body is connected to the distribution manifold, with an outlet of the nozzle coincident with an interior water-filled chamber of the valve body. A first seal element is removably seated against the nozzle outlet and an arm is hinged to the body and configured to apply a force along a seal axis and bias the first seal element into sealing engagement with the nozzle outlet until hydrocarbon pressure exceeds a sealing pressure of the applied force and unseats the first seal element from the nozzle outlet such that excess hydrocarbons exit through an outlet of the valve body. A weight is disposed on the arm at a distance from the seal axis.

### CROSS-REFERENCE TO RELATED APPLICATIONS

This application claims the benefit of U.S. Provisional Application No. 61/479,671 filed Apr. 27, 2011, and incorporated herein by reference.

### STATEMENT REGARDING FEDERALLY SPONSORED RESEARCH OR DEVELOPMENT

Not applicable.

### BACKGROUND

In producing oil and gas from offshore wells, a wellhead is employed at the seafloor and the hydrocarbons flow from the wellhead through tubular risers to the surface where the fluids are collected in a receiving facility located on a platform or other vessel. Normally, the flow of hydrocarbons is controlled via a series of valves installed on the wellhead, the risers, and in the receiving facility at the surface. At times, temporary flow lines from the wellhead to a receiving facility may be installed. In all such instances, it is important to prevent excessive pressure from building up in these lines. Such pressures could build up due to hydrate formation, sudden changes in pressure in the well bore, or back pressure from valve closings or from other processes. Pressures could cause equipment failures at the sea floor, which may be 5,000-7,000 feet or more below the surface. At those depths, the water pressure exceeds 2000 p.s.i. Because of the depth and pressures, effectuating repairs can require that equipment and tools be handled by deep diving, using, for example, remotely operated vehicles (ROV's) which are essentially robots controlled by an operator in a surface vessel. Controlling the vehicles from such distances and using the ROV's to repair and/or replace equipment and components is a difficult and time consuming task.

### SUMMARY OF THE DISCLOSURE

Accordingly, a device is required to limit pressures in the subsea flow lines and other hydrocarbon-containing equipment to non-destructive levels, and to relieve excess pressure when required. Any pressure relief device installed at the sea bed should be capable of reliable operation at the extreme pressures that are encountered, and withstand the highly-corrosive environment of the ocean. Further, it would be advantageous if the pressure setting at which the valve operates can be adjusted while the valve is installed and in position subsea, rather than having to disconnect the valve from a piping system and then make the lengthy trip to the surface for adjustment.

These and other needs in the art are addressed in one embodiment of a pressure relief valve. In an embodiment, the pressure relief valve includes a body having a chamber. In addition, the pressure relief valve includes a first seal element in the chamber that engages a second seal element to thereby prevent fluid passage into the chamber up to a predetermined fluid pressure. Further, the pressure relief valve includes an arm hinged to the body and applying a force along a seal axis and biasing the first and second seal element into sealing engagement. Still further, the pressure relief valve includes a weight disposed on the arm at a distance from the seal axis.

These and other needs in the art are addressed in another embodiment of a pressure relief valve for use submerged in a body of water. In an embodiment, the pressure relief valve includes a body. In addition, the pressure relief valve includes a first seal element disposed in the body in a chamber having an outlet into the body of water. Further, the pressure relief valve includes an arm coupled to the body and adapted to pivot. Still further, the pressure relief valve includes a weight positioned on the arm that supplies a moment that biases the first seal element into sealing engagement with a second seal element forming a seal effective against a predetermined pressure in the chamber.

These and other needs in the art are addressed in another embodiment of a subsea system for recovering hydrocarbons. In an embodiment, the system includes a subsea container having hydrocarbons retained therein. In addition, the system includes a pressure relief valve coupled to the subsea container and adapted to relieve pressure in the container if the pressure rises to a predetermined value. The relief valve includes a chamber that is flooded with seawater. The relief valve also includes a metal to metal seal in the flooded chamber. Further, the relief valve includes a moment arm biasing a first seal member into sealing engagement with a second seal member when the hydrocarbon pressure in the container is less than the predetermined value. Moreover, the relief valve includes an outlet to port into the sea hydrocarbons that enter the chamber when the hydrocarbon pressure in the container rises to the predetermined value.

These and other needs in the art are addressed in another embodiment of a pressure relief valve. In an embodiment, the pressure relief valve includes a nozzle in fluid communication with a container. In addition, the pressure relief valve includes a seal element disposed above the nozzle and adapted to move into and out of sealing engagement with the nozzle. Further, the pressure relief valve includes a weight positioned above the seal element and supported for reciprocal motion. The weight is adapted to force the seal element into sealing engagement with the nozzle until the pressure in the container equals or exceeds a predetermined pressure.

Thus, embodiments described herein include a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the disclosed embodiments of the invention, reference will now be made to the accompanying drawings in which:

FIG. 1 is a schematic view of an exemplary subsea hydrocarbon recovery system employing a subsea pressure relief valve made in accordance with principles described herein.

FIG. 2 is an elevation view, partly in cross section, of the pressure relief valve of FIG. 1.

FIG. 3 is a top view of the pressure relief valve of FIG. 2.

FIG. 4 is an elevation view, partly in cross section, of another pressure relief valve made in accordance with principles described herein.

### DETAILED DESCRIPTION

A pressure relief valve for underwater applications is disclosed herein. The valve can be employed in many underwater applications; however, it has particular application as a device to relieve overpressures that may develop in subsea flow lines, manifolds, tanks and vessels containing and/or transporting hydrocarbons from the sea floor. For convenience, the word “container” may be used herein to refer to at least all such hydrocarbon-containing lines, manifolds, tanks, and vessels.

The following description is exemplary of embodiments of the invention, but these embodiments are not to be interpreted or otherwise used as limiting the scope of the disclosure, including the claims. One skilled in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections.

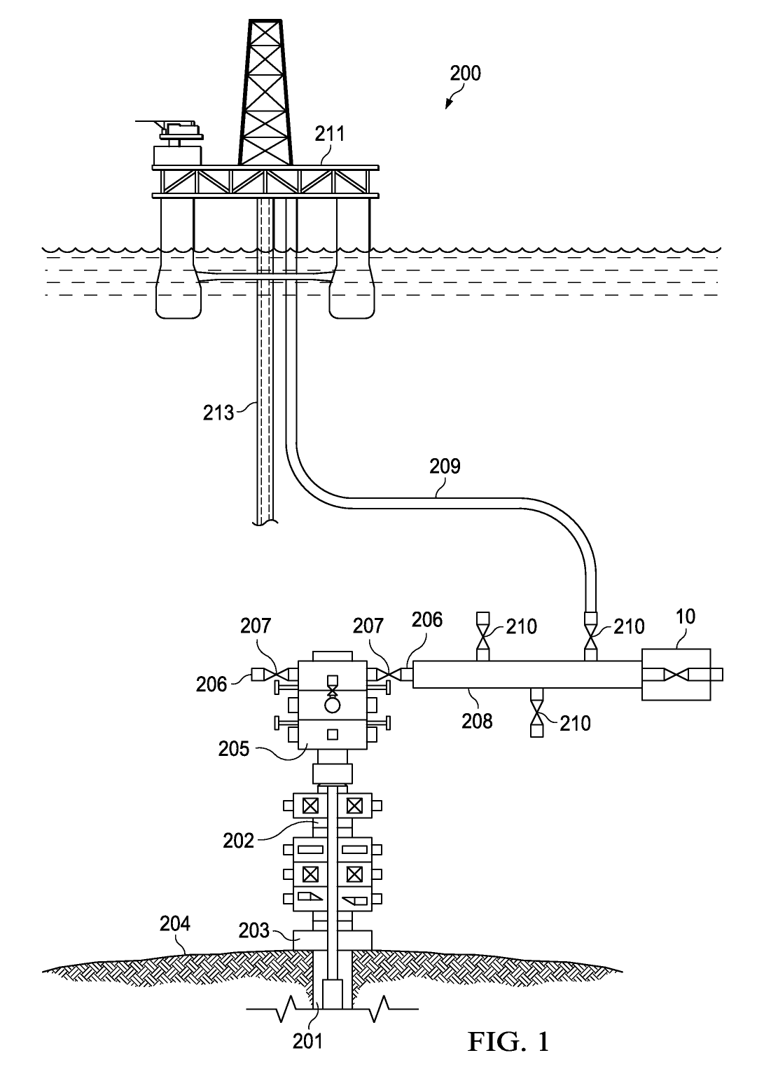

Referring to FIG. 1, an exemplary embodiment of an offshore system 200 for recovering hydrocarbons from a subsea wellbore 201 is shown. In this embodiment, system 200 includes a blowout preventer (BOP) 202 mounted to a wellhead 203 at the sea floor 204, and a capping stack 205 mounted atop BOP 202. In a typical system for producing from well 201, hydrocarbons are allowed to flow through the BOP 202, through a lower marine riser package (not shown), and through risers 213 to a hydrocarbon-receiving vessel at the surface, such as platform 211. In this example, however, capping stack 205 has been substituted for a lower marine riser package in a situation, for example, where hydrocarbon flow is not controlled via the normal path and is instead diverted and collected via an alternate collection system.

Capping stack 205 includes at least one fluid outlet 206 controlled by a valve 207 for controlling the flow of hydrocarbons from the well to various destinations, including into a distribution manifold 208. In turn, one or more flowlines 209 are connected to valved outlets 210 in the manifold 208 and are employed to transport the hydrocarbons from the well to one or more hydrocarbon storage vessels at the surface, such as platform 211. A pressure relief valve 10 is coupled to subsea manifold 208 and is in fluid communication with hydrocarbons contained in manifold 208. When valved outlet 210 interconnecting flowline 209 and manifold 208 is open, pressure relief valve 10 is likewise in fluid communication with flow line 209.

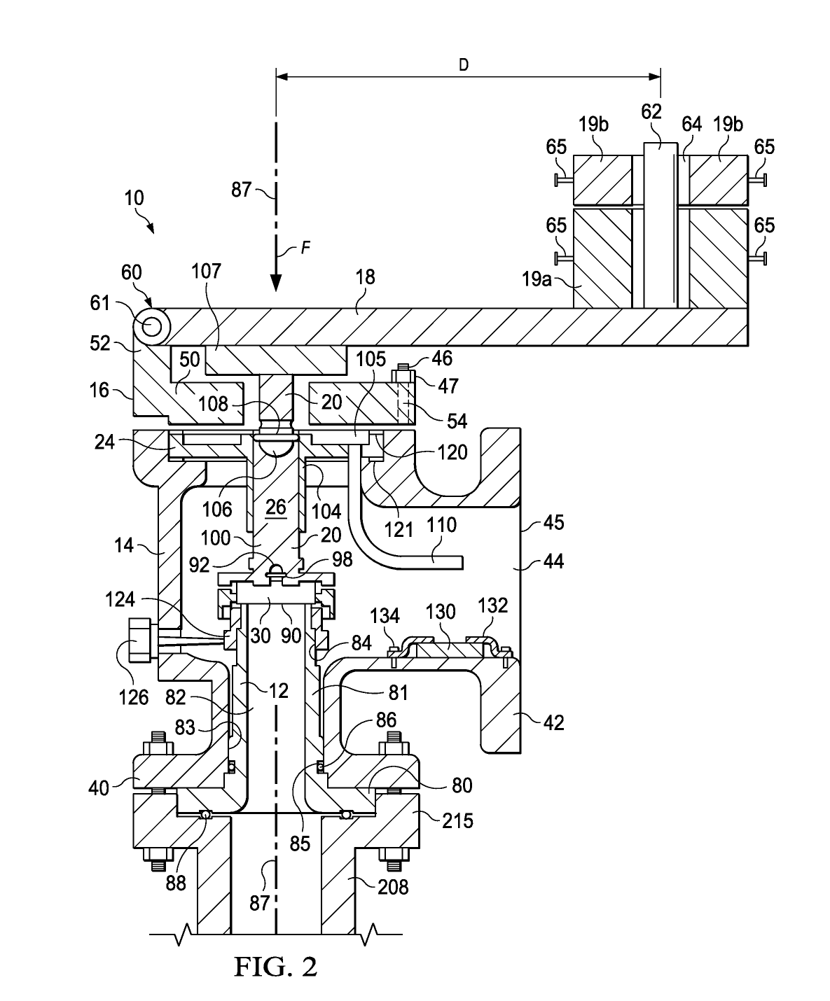

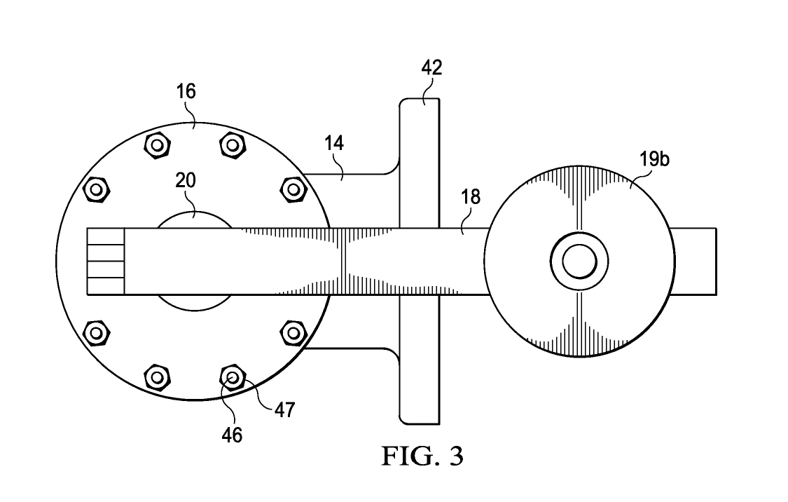

Referring now to FIGS. 2 and 3, pressure relief valve 10 generally includes nozzle 12, valve body 14, closure member 16, arm 18, and weights 19a, 19b. Valve 10 includes spindle 20, guide member 24, disk holder 26, and disk 30.

Valve body 14 includes base flange 40 for attaching pressure relief valve 10 to the distribution manifold 208, an outlet flange 42 suitable for connecting the valve body to another flow line or other vessel or container, and an interior chamber 44. In this embodiment, flange 42 is left unconnected, such that chamber 44 is open to the ambient environment and thus is flooded with seawater that enters the chamber 44 at outlet 45. The upper end of body 14 includes upwardly-extending studs 46 for attaching closure member 16.

Closure member 16 includes base plate 50, hinge support 52 and circumferentially-spaced apertures 54 formed through plate 50. Base plate 50 is circular in this embodiment; however base plates having other shapes may be employed. Hinge support 52 is an elongate member supporting hinge 60 at its upper end. Support 52 may be integrally formed with plate 50 or may be a separate member welded or otherwise coupled to the top of base plate 50.

Arm 18 is an elongated and substantially rigid member pivotally secured to hinge support 52 by hinge 60. Arm 18, which may be a bar, plate, channel or beam, such as an I-beam, extends from hinge 60 a predetermined distance and, in the embodiment shown in FIG. 2, includes an upwardly extending post 62 attached adjacent the unhinged end of the arm.

In the embodiment shown in FIG. 2, weights 19 (e.g. 19a and 19b) are “donut” or toroidal-shaped, each including a through bore 64 having a diameter that is larger than the thickness or diameter of post 62 on arm 18. Weights 19a and 19b are positioned on the arm 18 such that the post 62 is received within a through bore 64 of each weight. The engagement of post 62 through bores 64 retains the weights in position on arm 18. Weights 19 include a plurality of handles 65 to allow the weights 19 to be lifted and manipulated by ROV's. Handles 65 may be T-shaped or looped or in another form that makes the weights convenient to be handled by ROV's, or to be connected by cables for transporting. To allow ample access by the ROV's, weights 19 are free of any type of enclosure or covering in the embodiment shown in FIG. 2. In this manner, the weights 19a, 19b may be said to be unencumbered. Also as shown in the embodiment of FIG. 2, weights 19a and 19b have different sizes and different weights. In particular, the weight of 19a, in this example, is substantially greater than the weight of 19b. To achieve the desired force, a single weight 19 or a number of weights 19a, 19b, having differing weights, will be stacked on arm 18.

Although the disclosure to this point has described weights that are toroidal-shaped and that are retained on arm 18 via post 62, it is to be understood that the weights 19a, 19b may take any of a variety of other shapes, and may be formed without post-receiving bores. Further, arm 18 may be formed without post 62 and may, for example, instead be fitted with a bin or platform for receiving weights that are placed and/or stacked within or on the bin or platform.

Referring again to FIG. 2, hinge 60 interconnects hinge support 52 and arm 18 and is generally configured like a door hinge. More specifically, as best shown in FIGS. 2 and 3, in this embodiment, the ends of hinge support 52 and arm 18 include interlaced projections having aligned through-bores through which an elongate pin 61 is inserted. Hinge 60 serves to allow arm 18 to pivot about pin 61.

Referring again to FIGS. 2 and 3, nozzle 12 includes a lower base flange 80 and a tubular extension 81 extending along seal axis 87 and having interior 82 that is in fluid communication with the hydrocarbons in manifold 208. The outside surface of extension 81 includes two externally threaded segments 83 and 84, and seal groove 85. Annular seal 86 is disposed in seal groove 85 and seals between the nozzle 12 and valve body 14. Threaded segment 83 threadably engages a correspondingly threaded segment on the inner surface of valve body 14. The upper end of nozzle 12 forms seal rim 90, which engages sealing disk 30 when the pressure of the hydrocarbons within the manifold is below a predetermined value.

Disk 30 is centered along seal axis 87 and includes extension 92 on its upper end which is received in a mating recess in disk holder 26 and is aligned with axis 87. Retaining ring 98 retains disk 30 on disk holder 26. The upwardly-extending portion 100 of disk holder 26 is slidably received in the sleeve 104 of guide 24. Spindle 20 includes a flange portion 107 disposed between arm 18 and base plate 50, and a projection extending along seal axis 87 having a connecting end 106 that is retained in the upper end of disk holder 26 via retaining ring 108. Tube 110 extends between interior base chamber 44 through guide member 24 and opens into the annular chamber 105 that exists between the upper surface of guide 24 and closure member 16, thereby placing annular chamber 105 in fluid communication with interior base chamber 44. Given that outlet 45 of valve body 14 is open to receive sea water, and tube 110 extends between base chamber 44 and annular chamber 105, both chambers 44, 105 will be flooded with seawater and will experience the same pressure.

Studs 46 are connected to and extend upwardly from valve body 14 where they are received in aligned apertures 54 circumferentially spaced about base plate 50 of closure member 16. Retaining nuts 47 are disposed about the studs 46 to attach the closure member 16 to the body 14. Gaskets 120, 121 are optionally disposed between guide 24 and closure member 16, and between guide 24 and valve body 14, respectively. As sea water is intended to flood chambers 44, 105 in this application, a seal between closure 16 and valve body 14 is not required.

Blow-down adjusting ring 124 is disposed about threaded segment 84 on nozzle 12. Adjusting ring 124 is employed in order to adjust the size of the opening that is created after disk 30 lifts off nozzle rim 90 upon pressure in the manifold 208 reaching a predetermined maximum value, and thereby to adjust the pressure at which disk 30 will reseat on nozzle rim 90. Once ring 124 is appropriately adjusted, pin 126 fixes the ring's position and prevents the adjusting ring 124 from moving axially along nozzle 12.

The moment created by weights 19a, 19b being positioned on arm 18 at a distance D from seal axis 87 creates a downward force F that is applied to spindle 20 and disk holder 26 and, in turn, to disk 30 so that disk 30 seals against seal rim 90 of nozzle 12. The pressure brought to bear on those sealing surfaces of nozzle rim 90 and disk 30 is adjustable by means of adjusting the amount of weight applied to arm 18 and/or the distance it is applied from the seal axis 87. Although two weights, 19a and 19b, are shown in FIG. 2, the weight applied at distance D may be supplied by one, two, or more weights applied to arm 18. Weights 19a, 19b will each be manufactured to have a predetermined weight and, for example, may be made of steel, suitably coated for the environment. In the embodiment shown in FIGS. 2 and 3, the combined weights of 19a and 19b may be, for example, 150 lbs. with that weight being applied at a distance D of 3 ft. through a fulcrum displaced by 6 in. from valve centre line, which would resist a 500 psi set pressure acting over a 2 sq inch port/orifice. In this example, arm 18 may be made of a carbon steel beam.

Components of valve 10 may be made of corrosion-resistant materials such as Super Duplex stainless steel. Alternatively, components may be made of carbon steel. However, carbon steel is much more susceptible to corrosion. Due to the corrosive nature of seawater in this embodiment, cathodic protection is applied to slow corrosion, particularly if carbon steel is employed. Accordingly, as shown in the embodiment of FIG. 2, an anode 130 is disposed within chamber 44 and placed in direct engagement with body 14. Anode 130, which may be made of a material such as zinc or aluminum, for example, is fastened to body 14 in this embodiment by straps 132 and threaded fasteners 134, although it may be attached to be in engagement with body 14 by other means. In this manner, a degree of cathodic protection is provided to all metal components that are coupled, directly or indirectly, to body 14. Such cathodic protection can be accomplished by attaching anode 130 to other metallic portions of pressure relief valve 10; however, attaching anode 130 within chamber 44 is convenient, and also places the anode in a position less likely to be knocked loose and detached as the valve is transported and installed subsea.

Certain metals and alloys are detrimentally affected by the hydrogen gas that is formed when cathodic protection is provided. In particular, hard materials employed in certain high-strength bolts, for example, are particularly susceptible to cracking when exposed to hydrogen gas. Accordingly, in the example described above, select components may optionally be made of a material that is less-susceptible to cracking in the presence of hydrogen gas.

Base flange 80 of nozzle 12 is placed in engagement with the manifold 208 and positioned such that nozzle chamber 82 is in fluid communication with pressurized fluid within the manifold 208. Base flange 40 of body 14 is then bolted to a corresponding flange 215 on the manifold 208. Seal 88 seals between flange 80 and manifold 208. In such position, the central chamber 82 of nozzle 12 will be filled with the hydrocarbons and pressurized to the same extent as the manifold 208. Given that outlet 45 of valve body 14 is open to receive sea water, and that chamber 105 is in fluid communication with chamber 44 via tube 110, the entire valve is flooded with sea water and will experience the same pressure, such that the lift pressure required to unseat disk 30 from nozzle rim 90 will be unaffected by the tremendous pressure of the seawater even at great depths.

Should the pressure in manifold 208 and in chamber 82 of nozzle 12 create a force that exceeds the force provided by the predetermined and preapplied pressure supplied by arm 18 and weights 19a, 19b on disk 30, disk 30 will be unseated from rim 90 of nozzle 12, such that the pressurized hydrocarbons will exit nozzle 12 and enter chamber 44 and be expelled through outlet 45 into the surrounding seawater. When the excessive pressure is relieved and the pressure within manifold 208 drops to a pressure level less than that which causes the seal members to disengage, the force supplied by arm 18 and weights 19a, 19b will push the disk 30 back into sealing engagement with nozzle rim 90. At this point, the flow of hydrocarbons from manifold 208 into chamber 44 and the surrounding sea water is stopped.

The embodiment of FIGS. 2 and 3 provides a reliable pressure relief valve having few moving parts and allowing for ease of manufacture and installation and allowing for subsea adjustment. Specifically, the valve need not be taken to the surface in order to be readjusted. Instead, a number of weights may be positioned on arm 18 adjacent the sea floor and, using an ROV, the weights may be selected in varying combinations in order to achieve the desired weight on arm 18 to apply the appropriate force to resist the pressure of hydrocarbons in manifold 208. The pressure relief valve is free of springs, bellows and other components that may be susceptible to damage when used in the harsh subsea environment. Further, the valve, being completely flooded with seawater, is not susceptible to seal failure and is well-suited to operate at tremendous pressures that exist subsea.

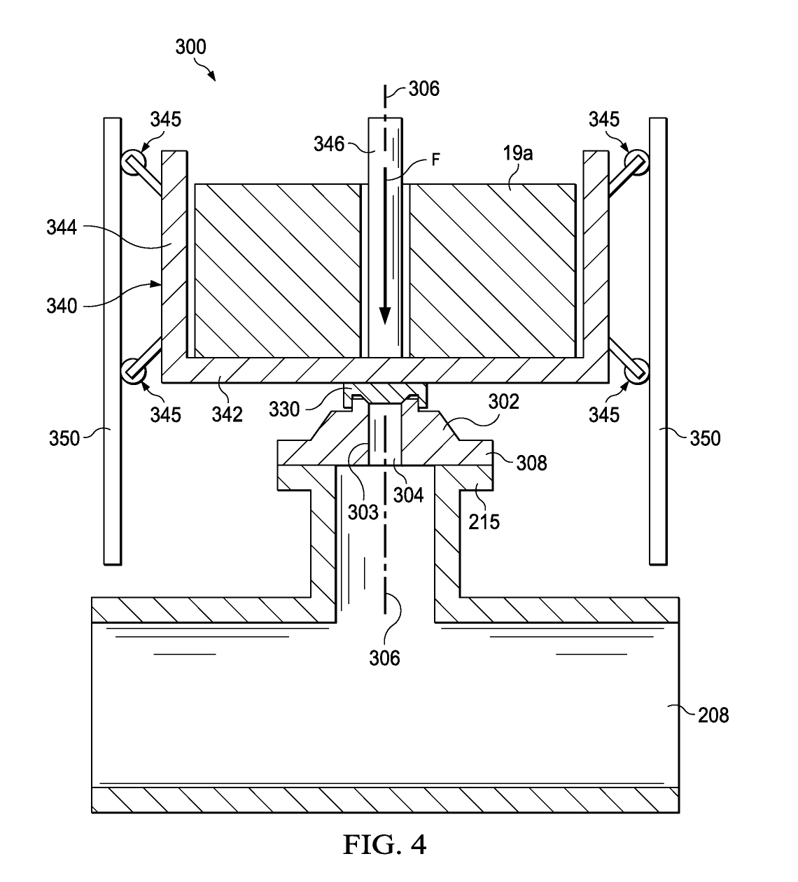

Referring to FIG. 4, an alternative subsea pressure relief valve 300 is shown and may be employed to control and relieve hydrocarbon pressure within manifold 208. Pressure relief valve 300 generally includes a body portion 302, seal disk 330, and weight bin 340 supporting weight 19a. In this embodiment, the weight 19a that is employed to resist the hydrocarbon pressure within manifold 208 and thereby control operation of seal disk 330 is disposed substantially aligned with seal axis 306, rather than being disposed at a distance D from the seal axis as in the design of valve 10 described with reference to FIG. 2.

Referring still to FIG. 4, valve body 302 includes central nozzle 303 having chamber 304 disposed about seal axis 306. Body 302 further includes flange 308 coupled to flange 215 of manifold 208.

Seal disk 330 is disposed atop valve body 302, the lower surface of disk 330 sealing against nozzle 303 when the appropriate force F is applied. Weight bin 340 is a weight-receiving cart or receptacle that is coupled to the upper surface of seal disk 330 and generally comprises bottom 342 and a pair of side panels 344. In this embodiment of FIG. 4, weight bin 340 is open on its other sides and has no top. Extending along seal axis 306 is post 346 that is coupled to bottom 342 of the weight bin 340. One or more toroidal-shaped weights, such as weight 19a previously described, is supported within weight bin 340 and disposed about post 346.

In the embodiment of FIG. 4, roller assemblies 345 extend between sides 344 of weight bin 340 and support members 350. Support members 350, shown schematically, are supported from the seabed or other rigid structure and located so as to position weight bin 340 in substantial alignment with seal axis 306.

Optionally, other means of retaining weights above valve body 302 and seal axis 306 may be employed. For example, bin 340 may be formed without post 346, and weights may have shapes other than toroidal shapes and be retained on bottom 342 of bin 340 by gravity alone, or by other fastening configurations. Similarly, bin 340 may include portions that slide, without rollers, against support members 350.

In operation, the appropriate weight 19a is placed over post 346 in weight bin 340 to apply the predetermined force F against disk seal 330. Weight 19a may be positioned in bin 340 after installation of valve 300 on manifold 208. Similarly, weights can be added or exchanged in weight bin 340 in order to adjust the force F against seal disc 330. When hydrocarbon pressure with the manifold 208 reaches a predetermined maximum and supplies a lifting force to seal disk 330 to cause it to unseat and lift, bin 340 raises when the disk becomes unseated. Bin 340 is allowed to move axially in a direction along seal axis 306 as rollers of roller assemblies 345 roll along supports 350.

As compared to pressure relief valve 10 previously described, valve 300 will require a substantially larger weight 19 for the same hydrocarbon pressure in manifold 208. This is because the weight in valve 300 is supplied substantially along seal axis 306, rather than at a distance D as in valve 10. In other words, valve 10 shown in FIG. 2 allows a substantially lower weight to achieve the same seal force as a result of the moment provided by arm 18. Nevertheless, the design of valve 300, like valve 10, has few moving parts, is a generally simple and rugged design that can function subsea at great pressures, and that does not require that components be isolated from the surrounding seawater. Further, it allows for subsea weight adjustment when the valve is installed subsea, and eliminates the need to transport the valve to the surface in order to adjust the sealing force applied.

While preferred embodiments have been shown and described, modifications thereof can be made by one skilled in the art without departing from the scope or teachings herein. The embodiments described herein are exemplary only, and are not limiting. Many variations and modifications of the disclosed apparatus are possible and are within the scope of the invention. Accordingly, the scope of protection is not limited to the embodiments described herein, but is only limited by the claims that follow, the scope of which shall include all equivalents of the subject matter of the claims.

What is claimed is:

1. A subsea pressure relief valve comprising:
a water-filled nozzle connected to a hydrocarbon distribution manifold;
a valve body connected to the distribution manifold, an outlet of the nozzle coincident with an interior water-filled chamber of the valve body;
a first seal element removably seated against the nozzle outlet;
an arm hinged to the body and configured to apply a force along a seal axis and bias the first seal element into sealing engagement with the nozzle outlet until hydrocarbon pressure exceeds a sealing pressure of the applied force and unseats the first seal element from the nozzle outlet such that excess hydrocarbons exit through an outlet of the valve body; and
a weight disposed on the arm at a distance from the seal axis.

2. The pressure relief valve of claim 1, further comprising: a plate having a through bore that is disposed atop the body, and a spindle member having an extending portion disposed in the bore and extending generally along the seal axis.

3. The pressure relief valve of claim 2, further comprising a holding member disposed between the spindle member and the first seal element.

4. The pressure relief valve of claim 1, wherein the chamber is open to the ambient environment.

5. The pressure relief valve of claim 1, wherein the weight includes a through passage disposed about a post extending from the arm.

6. A subsea pressure relief valve comprising:
a valve body;
a nozzle in fluid communication with a container;
a seal element disposed within the valve body and adapted to move into and out of sealing engagement with the nozzle; and
a weight on an arm supplying a moment that forces the seal element into sealing engagement with the nozzle at a predetermined force.

7. The pressure relief valve of claim 6, wherein the arm is hinged to the valve body.

8. The pressure relief valve of claim 6, wherein the seal element is positioned in a water-filled chamber in the valve body.

9. The pressure relief valve of claim 7, further comprising:
a closure member on top of the valve body, and having a hole therethrough; and
a spindle disposed between the closure member and the arm and having an extending portion passing through the hole, wherein the spindle portion is adapted to engage the arm and apply downward force through the extending portion.

10. The pressure relief valve of claim 7, wherein the arm includes a post, and wherein the weight includes a through bore that receives the post therein.

11. The pressure relief valve of claim 8, further comprising an anode in engagement with the valve body.

12. A subsea pressure relief valve comprising:
a body;
a first seal element disposed in the body in a chamber having an outlet into a body of water;
an arm pivotally coupled to the body;
a weight positioned on the arm and supplying a moment that biases the first seal element into sealing engagement with a second seal element forming a seal effective against a predetermined pressure in the chamber.

13. The pressure relief valve of claim 12, wherein the first seal element is adapted to move axially along a seal axis, and wherein the weight is positioned on the arm at a predetermined distance so as to apply a downward force generally aligned with the seal axis.

14. The pressure relief valve of claim 13, wherein the weight comprises a plurality of stacked weights.

15. The pressure relief valve of claim 12, wherein the arm includes a post member and the weight includes a through bore that receives the post.

16. The pressure relief valve of claim 12, wherein the predetermined pressure is adjustable by changing the weight that is positioned on the arm.

17. The pressure relief valve of claim 13, wherein access to the weight is unencumbered.

18. A subsea system for recovering hydrocarbons, comprising:
a subsea container having hydrocarbons retained therein; and
a pressure relief valve coupled to the subsea container and adapted to relieve pressure in the container if the pressure rises to a predetermined value, the relief valve comprising:
a chamber flooded with water;
a metal-to-metal seal in the chamber;
a moment arm biasing a first seal member into sealing engagement with a second seal member when the hydrocarbon pressure in the container is less than the predetermined value; and
an outlet to port into the sea hydrocarbons that enter the chamber when the hydrocarbon pressure in the container rises to the predetermined value.

19. The subsea system of claim 18, wherein the first seal member is adapted to move axially in the chamber along a seal axis, and wherein the moment arm comprises an elongate member hinged at a first end to the pressure relief valve, and wherein the elongate member having a weight disposed thereon at a predetermined distance from the seal axis is configured to apply a downward force along the seal axis.

20. The subsea system of claim 19, wherein the pressure at which the pressure relief valve opens is adjustable by changing the weight applied to the moment arm.

21. The subsea system of claim 20, wherein the weight used to adjust the pressure at which the pressure relief valve operates is unenclosed and surrounded by water.

22. A pressure relief valve comprising:
a nozzle in fluid communication with a container;
a seal element disposed above the nozzle and adapted to move into and out of sealing engagement with the nozzle; and
a weight positioned above the seal element and supported for reciprocal motion;
the weight adapted to force the seal element into sealing engagement with the nozzle until the pressure in the container equals or exceeds a predetermined value.

23. The pressure relief valve of claim 22, further comprising a weight-receiving receptacle disposed atop the seal element, said weight being positioned in said receptacle.
